(19) United States
(12) Patent Application Publication
(10) Pub. No.: US 2017/0103144 A1
(43) Pub. Date: Apr. 13, 2017

(54) WELL TRAJECTORY ADJUSTMENT

(71) Applicants: SCHLUMBEGER TECHNOLOGY CORPORATION, Sugar Land, TX (US); SAUDI ARABIAN OIL COMPANY, Dhahran (SA)

(72) Inventors: Mohammed Badri, Al-Khobar (SA); Shouxiang Ma, Dhahran (SA); Ping Zhang, Albany, CA (US); Wael Abdallah, Dhahran (SA)

(21) Appl. No.: 14/878,283

(22) Filed: Oct. 8, 2015

(51) Int. Cl. G06F 17/50

(52) U.S. Cl. CPC G06F 17/5004

(57) ABSTRACT

Well trajectory adjustment is provided. In one possible implementation, an initial 3D model of a portion of a formation in which a well is being drilled is accessed. Subsurface data associated with the formation is then used to tune the initial 3D model to create a revised 3D model. In another possible implementation, subsurface data associated with a formation in which a well is being drilled is used to tune an initial 3D model of the formation to create a revised 3D model. An initial planned trajectory of the well can also be adjusted to reach a sweet spot in the revised 3D model.

### BACKGROUND

In the field of oilfield services, guided drilling is often used to tap into hydrocarbon sweet spots and improve both oil recovery and sweep efficiency. However, guided drilling does not come without expense. For example, guided drilling frequently entails a variety of equipment and specialists, rendering it both cumbersome and costly in terms of time, money and other resources. Thus, guided drilling of a well can entail shifting resources from various other potentially profitable endeavors.

For these reasons, substantial pressure exists for drillers to streamline their operations and achieve drilling goals as quickly as possible. Pressure also exists for drillers to avoid drilling empty wells which fail to reach hydrocarbon deposits.

### SUMMARY

Well trajectory adjustment is provided. In one possible implementation, an initial 3D model of a formation in which a well is being drilled is accessed. Subsurface data associated with the formation is then used to tune the initial 3D model to create a revised 3D model.

In another possible implementation, subsurface data associated with a formation in which a well is being drilled is used to tune an initial 3D model of the formation to create a revised 3D model. An initial planned trajectory of the well can also be adjusted to reach a sweet spot in the revised 3D model.

In another possible implementation, a computer-readable tangible medium includes instructions that direct a processor to access an initial 3D model of a formation in which a well is being drilled. Instructions are also present that direct the processor to access subsurface data associated with the formation and create a revised 3D model by adjusting the initial 3D model based on the subsurface data.

This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example wellsite in which embodiments of well trajectory adjustment can be employed;

FIG. 2 illustrates an example computing device that can be used in accordance with various implementations of well trajectory adjustment;

FIG. 3 illustrates an example initial 3D model of a formation in accordance with implementations of well trajectory adjustment;

FIG. 4 illustrates an example revised 3D model of a formation in accordance with implementations of well trajectory adjustment;

FIG. 5 illustrates an example method associated with embodiments of well trajectory adjustment;

FIG. 6 illustrates an example method associated with embodiments of well trajectory adjustment;

FIG. 7 illustrates an example method associated with embodiments of well trajectory adjustment; and

FIG. 8 illustrates an example method associated with embodiments of well trajectory adjustment;

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

Additionally, some examples discussed herein involve technologies associated with the oilfield services industry. It will be understood however that the techniques of well trajectory adjustment may also be useful in a wide range of industries outside of the oilfield services sector, including for example, mining, geological surveying, chemical analysis, etc.

As described herein, various techniques and technologies associated with well trajectory adjustment can allow for a better understanding of a formation in which a well is being drilled. For example, in one possible implementation, subsurface data collected while the well is being drilled can be used to tune an initial 3D model of the formation and create a revised 3D model of the formation. This revised 3D model can then be used, for example, to adjust a planned trajectory of the drilled well to allow the well to more expeditiously reach a hydrocarbon sweet spot in the formation.

### Example Wellsite

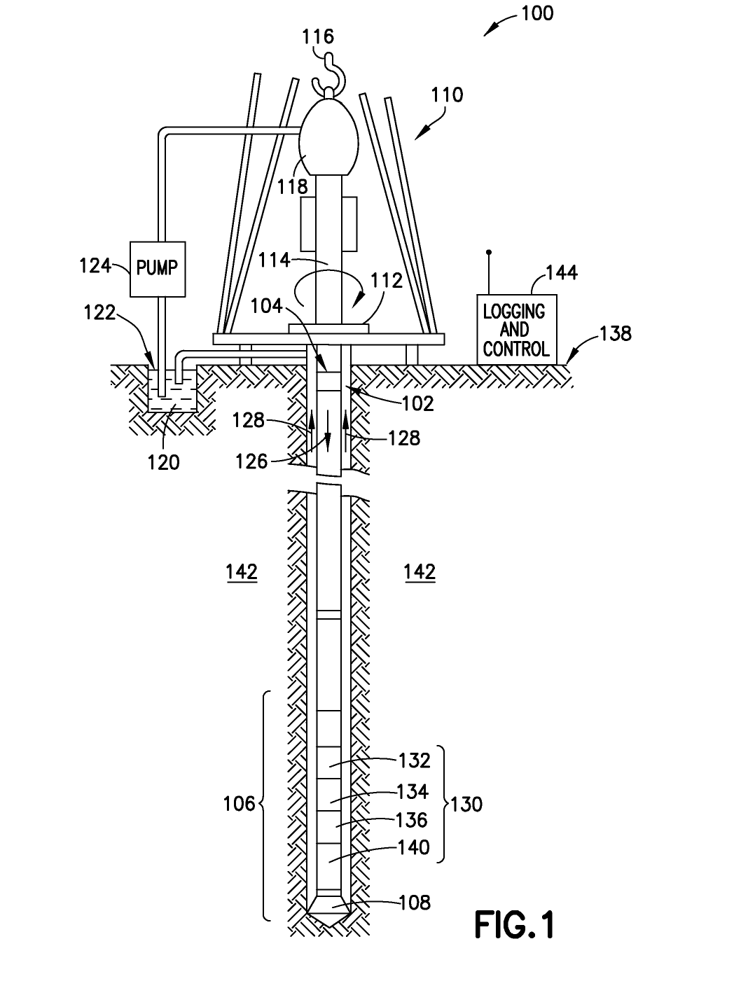

FIG. 1 illustrates a wellsite 100 in which embodiments of well trajectory adjustment can be employed. Wellsite 100 can be onshore or offshore. In this example system, a borehole 102 is formed in a subsurface formation by rotary drilling in a manner that is well known. Embodiments of well trajectory adjustment can also be employed in association with wellsites where directional drilling is being conducted.

A drill string 104 can be suspended within borehole 102 and have a bottom hole assembly 106 including a drill bit 108 at its lower end. The surface system can include a platform and derrick assembly 110 positioned over the borehole 102. The assembly 110 can include a rotary table 112, kelly 114, hook 116 and rotary swivel 118. The drill string 104 can be rotated by the rotary table 112, energized by means not shown, which engages kelly 114 at an upper end of drill string 104. Drill string 104 can be suspended from hook 116, attached to a traveling block (also not shown), through kelly 114 and a rotary swivel 118 which can permit rotation of drill string 104 relative to hook 116. As is well known, a top drive system can also be used.

In the example of this embodiment, the surface system can further include drilling fluid or mud 120 stored in a pit 122 formed at wellsite 100. A pump 124 can deliver drilling fluid 120 to an interior of drill string 104 via a port in swivel 118, causing drilling fluid 120 to flow downwardly through drill string 104 as indicated by directional arrow 126. Drilling fluid 120 can exit drill string 104 via ports in drill bit 108, and circulate upwardly through the annulus region between the outside of drill string 104 and wall of the borehole 102, as indicated by directional arrows 128. In this well-known manner, drilling fluid 120 can lubricate drill bit 108 and carry formation cuttings up to the surface as drilling fluid 120 is returned to pit 122 for recirculation.

Bottom hole assembly 106 of the illustrated embodiment can include drill bit 108 as well as a variety of equipment 130, including a logging-while-drilling (LWD) module 132, a measuring-while-drilling (MWD) module 134, a rotary-steerable system and motor, various other tools, etc.

In one possible implementation, LWD module 132 can be housed in a special type of drill collar, as is known in the art, and can include one or more of a plurality of known types of logging tools (e.g., a nuclear magnetic resonance (NMR system), a directional resistivity system, and/or a sonic logging system, etc). It will also be understood that more than one LWD and/or MWD module can be employed (e.g. as represented at position 136). (References, throughout, to a module at position 132 can also mean a module at position 136 as well). LWD module 132 can include capabilities for measuring, processing, and storing information, as well as for communicating with surface equipment.

MWD module 134 can also be housed in a special type of drill collar, as is known in the art, and include one or more devices for measuring characteristics of the well environment, such as characteristics of the drill string and drill bit. MWD module 134 can further include an apparatus (not shown) for generating electrical power to the downhole system. This may include a mud turbine generator powered by the flow of drilling fluid 120, it being understood that other power and/or battery systems may be employed. MWD module 134 can include one or more of a variety of measuring devices known in the art including, for example, a weight-on-bit measuring device, a torque measuring device, a vibration measuring device, a shock measuring device, a stick slip measuring device, a direction measuring device, and an inclination measuring device.

Various systems and methods can be used to transmit information (data and/or commands) from equipment 130 to a surface 138 of the wellsite 100. In one implementation, information can be received by one or more sensors 140. The sensors 140 can be located in a variety of locations and can be chosen from any sensing and/or detecting technology known in the art, including those capable of measuring various types of radiation, electric or magnetic fields, including electrodes (such as stakes), magnetometers, coils, etc.

In one possible implementation, information from equipment 130, including LWD data and/or MWD data, can be utilized for a variety of purposes including steering drill bit 108 and any tools associated therewith, characterizing a formation 142 surrounding borehole 102, characterizing fluids within wellbore 102, etc.

In one implementation a logging and control system 144 can be present. Logging and control system 144 can receive and process a variety of information from a variety of sources, including equipment 130. Logging and control system 144 can also control a variety of equipment, such as equipment 130 and drill bit 108.

Logging and control system 144 can also be used with a wide variety of oilfield applications, including logging while drilling, artificial lift, measuring while drilling, wireline, etc. Also, logging and control system 144 can be located at surface 138, below surface 138, proximate to borehole 102, remote from borehole 102, or any combination thereof

For example, in one possible implementation, information received by equipment 130 and/or sensors 140 can be processed by logging and control system 144 at one or more locations, including any configuration known in the art, such as in one or more handheld devices proximate and/or remote from the wellsite 100, at a computer located at a remote command center, etc.

### Example Computing Device

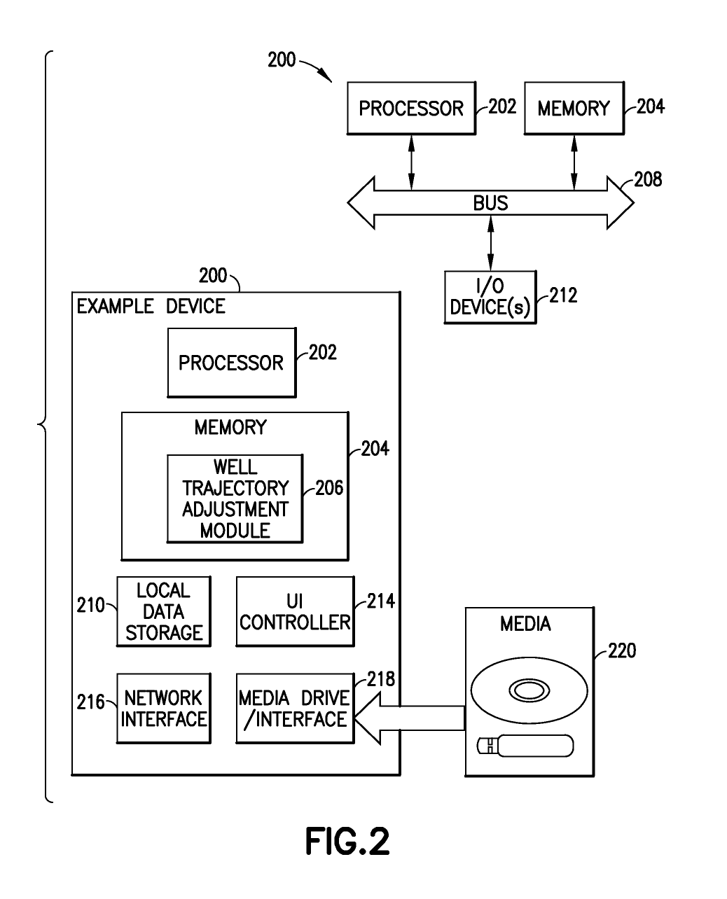

FIG. 2 illustrates an example device 200, with a processor 202 and memory 204 for hosting an well trajectory adjustment module 206 configured to implement various embodiments of well trajectory adjustment as discussed in this disclosure. Memory 204 can also host one or more databases and can include one or more forms of volatile data storage media such as random access memory (RAM), and/or one or more forms of nonvolatile storage media (such as read-only memory (ROM), flash memory, and so forth).

Device 200 is one example of a computing device or programmable device, and is not intended to suggest any limitation as to scope of use or functionality of device 200 and/or its possible architectures. For example, device 200 can comprise one or more computing devices, programmable logic controllers (PLCs), etc.

Further, device 200 should not be interpreted as having any dependency relating to one or a combination of components illustrated in device 200. For example, device 200 may include one or more of a computer, such as a laptop computer, a desktop computer, a mainframe computer, etc., or any combination or accumulation thereof

Device 200 can also include a bus 208 configured to allow various components and devices, such as processors 202, memory 204, and local data storage 210, among other components, to communicate with each other.

Bus 208 can include one or more of any of several types of bus structures, including a memory bus or memory controller, a peripheral bus, an accelerated graphics port, and a processor or local bus using any of a variety of bus architectures. Bus 208 can also include wired and/or wireless buses.

Local data storage 210 can include fixed media (e.g., RAM, ROM, a fixed hard drive, etc.) as well as removable media (e.g., a flash memory drive, a removable hard drive, optical disks, magnetic disks, and so forth).

One or more input/output (I/O) device(s) 212 may also communicate via a user interface (UI) controller 214, which may connect with I/O device(s) 212 either directly or through bus 208.

In one possible implementation, a network interface 216 may communicate outside of device 200 via a connected network, and in some implementations may communicate with hardware, such as equipment 130, one or more sensors 140, etc.

In one possible embodiment, equipment 130 may communicate with device 200 as input/output device(s) 212 via bus 208, such as via a USB port, for example.

A media drive/interface 218 can accept removable tangible media 220, such as flash drives, optical disks, removable hard drives, software products, etc. In one possible implementation, logic, computing instructions, and/or software programs comprising elements of well trajectory adjustment module 206 may reside on removable media 220 readable by media drive/interface 218.

In one possible embodiment, input/output device(s) 212 can allow a user to enter commands and information to device 200, and also allow information to be presented to the user and/or other components or devices. Examples of input device(s) 212 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of well trajectory adjustment module 206 may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

In one possible implementation, device 200, or a plurality thereof, can be employed at wellsite 100. This can include, for example, in various equipment 130, in logging and control system 144, etc.

### Example System(s) and/or Technique(s)

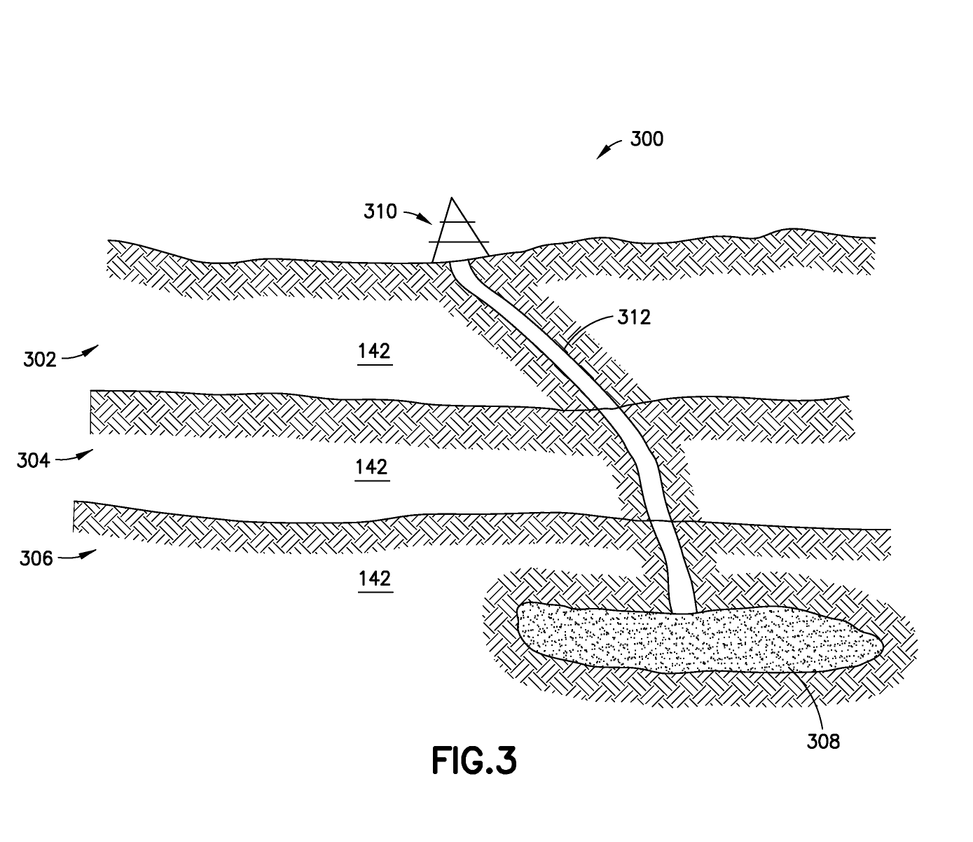

FIG. 3 illustrates an example initial 3D model 300 of formation 142 in accordance with implementations of well trajectory adjustment. Initial 3D model 300 can include any 3D model known in the art, including, for example, 3D resistivity models, 3D gravity models, etc., and can be created using any technologies known in the art, including, for example electromagnetic (EM) surveying (EM logging in a wellbore, cross-wellbore EM, borehole-surface or surface to borehole EM) technologies.

In one possible aspect, initial 3D model 300 can include an initial subsurface anisotropic 3D resistivity model defined by surface EM surveys. This can include, for example, a subsurface resistivity map created using one or more principles of electromagnetic induction and inversion to account for structures in formation 142 with differing orientations and dipping resistivity volumes.

As illustrated, initial 3D model 300 includes several layers 302, 304, 306 of varying resistivity, though it will be understood that more or fewer layers of varying resistivity may also be represented in initial 3D model 300. In layer 306 a sweet spot 308 is illustrated in formation 142. Sweet spot 308 can include an untapped hydrocarbon reserve, or any other area of interest which might be a potential drilling target, such as by-passed hydrocarbon after waterflooding.

In one possible implementation, initial 3D model 300 can be defined for any given survey region, including any layers 302, 304, 306, in formation 142 and can serve as a reference for placement of a well 310. Initial 3D model 300 can also be used to design an initial planned trajectory 312 of well 310 targeting sweet spot 308.

In one possible aspect, initial 3D model 300 can be accompanied by uncertainty due to the nature and limitations of the various technologies used to create initial 3D model 300. For example, it may be possible that an original survey used to create initial 3D model 300 was created with improperly calibrated accusation parameters for mapping and/or identification of sweet spot 308. In such a case the survey could lack the desired sensitivity to accurately define a location of sweet spot 308.

Alternately, or additionally, when resistivity modeling is used, due to possible absence of various geophysical and geological data, inversion may not be effectively constrained such that the resulting resistivity model may not be unique. Possible factors such as these (and others) can create uncertainty in assessing fluid distribution and locations of sweet spot 308 in formation 142.

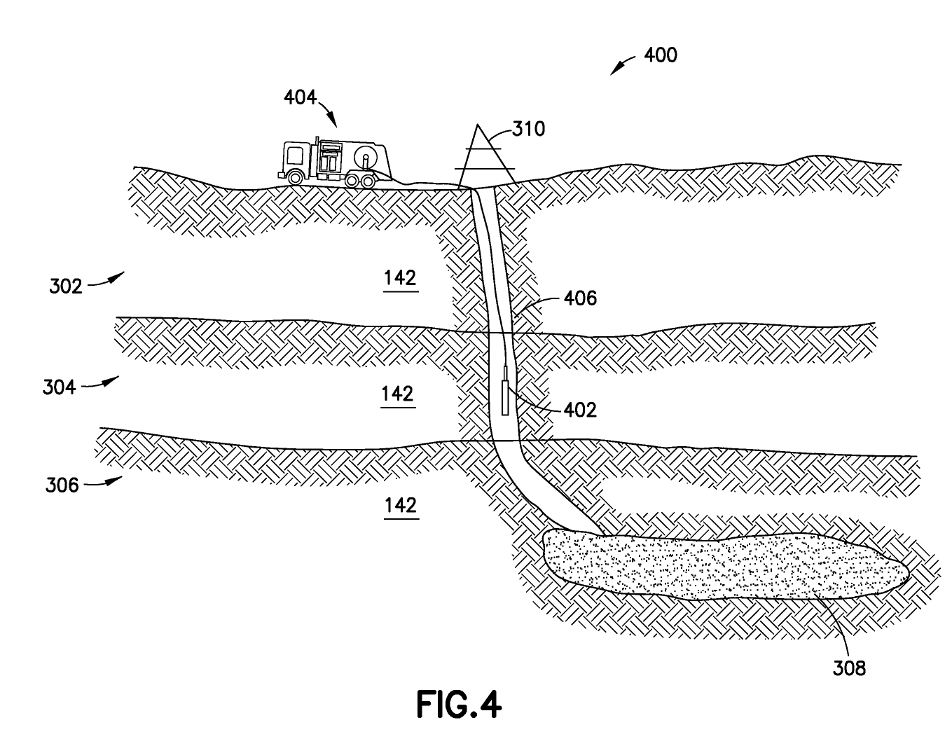

FIG. 4 illustrates an example revised 3D model 400 of formation 142 in accordance with implementations of well trajectory adjustment. In one possible implementation, revised 3D model 400 can be created by updating and/or calibrating initial 3D model 300, such as, for example, during the process of drilling well 310 in formation 142. In one possible aspect, such updating and calibration may reduce drilling risks associated with reaching sweet spot 308.

For instance, in one possible implementation, a synthetic log (such as, for example, a synthetic resistivity log) can be extracted from initial 3D model 300 along initial planned trajectory 312 of well 310.

As drilling of well 310 progresses along initial planned trajectory 312, various subsurface data can be collected. Numerous drilling techniques, including any types of guided drilling known in the art, can be employed to drill well 310 into formation 142 and facilitate hydrocarbon recovery from sweet spot 308. These various drilling techniques may also facilitate improved sweep efficiency.

In one possible implementation, subsurface data can be associated with various aspects of formation 142 and/or equipment used to drill well 310 on initial planned trajectory 312. For example, subsurface data can include data collected using one or more downhole instruments 402 (such as, equipment 130, including for example, LWD module 132 and MWD module 134, and/or sensors 140, etc.). Subsurface data can also include data associated with one or more formation materials such as advance fluids, cuttings, etc., received from the drilling of well 310.

Thus subsurface data can include electromagnetic (EM) measurements of formation 142 (including, for example, real time deep, directional EM measurements), and logs of resistivity, pressure and/or temperature based on logging-while-drilling (LWD) data associated with well 310. In one possible aspect, LWD data can also be seen to include data collected by MWD module 134 and/or any sensors 140 associated with borehole 304.

In one possible implementation, subsurface data can be acquired through various resistivity logging services. Such services, including those performed at LWD module 132 can, for example, reveal subsurface-bedding and fluid-contact details in proximity to a borehole being drilled for well 310.

Once collected, the various subsurface data can be analyzed. In one possible implementation, such analysis can take place in a data processing center 404, such as, for example, logging and control system 144. All or part of data processing center 404 can be onsite at a wellsite, or remote from the wellsite, such as at one or more control centers, data processing centers, etc.

In one possible implementation, initial 3D model 300 can be constrained and/or refined using some or all of the subsurface date to create revised 3D model 400. For example, in one possible embodiment, subsurface data can be used to reprocess initial 3D model 300, leading to improved definition (as drilling of well 310 progresses) of various quantities and/or qualities associated with formation 142 including, for example, bed geometries, lateral changes in the resistivity volume, distributions and/or concentrations of various fluids, etc., in initial 3D model 300.

In one possible aspect, revised 3D model 400 can more properly account for structures in formation 142 with different dipping angles and deviated wells. This can, for example, be used to guide drilling efforts on a target horizon and allow operators to improve landing and reservoir exposure and adjust initial planned trajectory 312 to improving targeting of sweet spot 308.

In another possible implementation, revised 3D model 400 can be used to improve modeling of various fluids in formation 142. For example, in one possible implementation, analysis of the subsurface data can be used to construct and/or update a fluid saturation cube in which fluids in at least a portion of formation 142 are mapped. The subsurface data can also be used to generate volumes of various fluid types present in formation 142, such as, for example, brine water distribution volumes and hydrocarbon distribution volumes based on, for example, the resistive natures of the various fluids. In one possible aspect, such generated fluid volumes can be used to derive a 3D bulk matrix volume associated with portions of formation 142 by, for example, subtracting one or more of the generated fluid volumes from revised 3D model 400 (such as by subtracting the one or more generated fluid models from a resistivity component of revised 3D model 400).

In yet another possible implementation, revised 3D model 400 can be combined with a 3D density model of formation 142 to generate a 3D pressure volume model which can in turn be used to derive, for example, a 3D window of mud weight within borehole 406. Such a 3D window of mud weight can be used, for example, to support drillers deciding on mud weight at various depths and/or provide a kick prediction method which can be used to avoid kick detection.

In one possible embodiment, revised 3D model 400 may be similar to initial 3D model 300, though the spatial distribution of various features, including resistivity features, can be changed and/or updated in revised 3D model 400. For example, in one possible embodiment, the location, size, orientation, etc., of sweet spot 308 in revised 3D model 400 may be different than that found in initial 3D model 300.

In one possible implementation, revised 3D model 400 can more accurately portray at least a portion of reservoir 142 than can initial 3D model 300.

In one possible implementation, initial planned trajectory 312 of the well being drilled can be adjusted to create a revised trajectory 406 of the well being drilled based at least in part on revised 3D model 400. In one possible embodiment, revised trajectory 406 of the well can result in an improved outcome, such as a more direct trajectory 406 to sweet spot 308, a faster drilling time to reach sweet spot 308, etc.

In one possible aspect, tuning of a trajectory of a well being drilled as described herein (for example refining initial planned trajectory 312 to create revised trajectory 406) can happen in real time. Moreover, tuning of a trajectory of a well being drilled as described herein can continue as many times as desired. For example, initial planned trajectory 312 can be revised to create revised trajectory 406. Then revised trajectory 406 can be revised to create a second revised trajectory, which in turn can be revised to create a third revised trajectory, and so on. In one possible implementation, creation of revised trajectories can continue until sweet spot 308 is reached.

### Example Methods

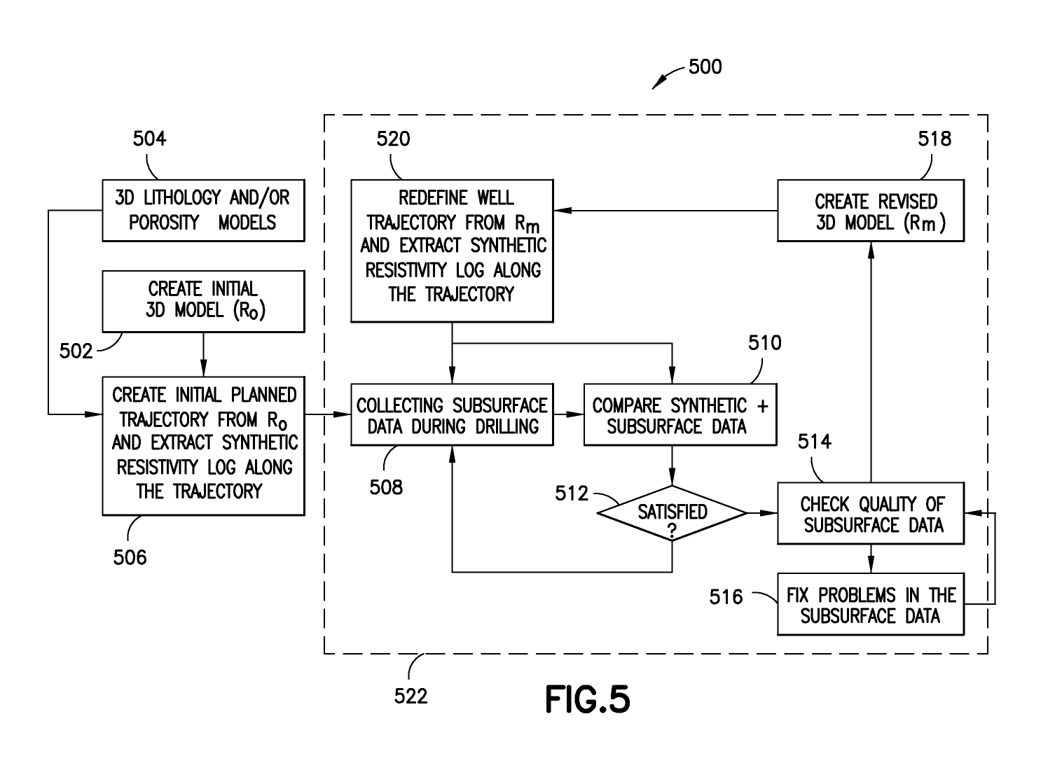

FIGS. 5-8 illustrate example methods for implementing aspects of well trajectory adjustment. The methods are illustrated as a collection of blocks and other elements in a logical flow graph representing a sequence of operations that can be implemented in hardware, software, firmware, various logic or any combination thereof. The order in which the methods are described is not intended to be construed as a limitation, and any number of the described method blocks can be combined in any order to implement the methods, or alternate methods. Additionally, individual blocks and/or elements may be deleted from the methods without departing from the spirit and scope of the subject matter described therein. In the context of software, the blocks and other elements can represent computer instructions that, when executed by one or more processors, perform the recited operations. Moreover, for discussion purposes, and not purposes of limitation, selected aspects of the methods may be described with reference to elements shown in FIGS. 1-4.

FIG. 5 illustrates an example method 500 associated with embodiments of well trajectory adjustment. At block 502 an initial 3D model Rₒ, such as for example initial 3D model 300, is created and/or accessed. In one possible implementation, initial 3D model Rₒ includes an anisotropic 3D resistivity model.

At block 504, 3D lithology and/or porosity models can be accessed. In one possible implementation, these models can be included into, and/or used in conjunction with, the initial 3D model Rₒ.

At block 506, information associated with the initial 3D model Rₒ can be used to create an initial planned well trajectory, such as initial planned well trajectory 312. In one possible implementation, a synthetic resistivity log can be extracted from the initial 3D Model Rₒ along the initial planned trajectory.

At block 508, once drilling of a well (such as well 310) has commenced along the initial planned trajectory, subsurface data can be collected. Subsurface data can include data associated with various aspects of a formation (such as formation 142) in which the well is being drilled and/or equipment used to drill the well on its planned trajectory. For example, subsurface data can include data collected using one or more downhole instruments (such as, for example, various equipment 130, sensors 140, etc.) Subsurface data can also include data associated with one or more formation materials such as advance fluids, cuttings, etc., received from the drilling of the borehole. Subsurface data can include electromagnetic (EM) measurements of the formation (including, for example, real time deep, directional EM measurements), and logs of resistivity, pressure and/or temperature based on logging-while-drilling (LWD) data associated with the well being drilled. In one possible implementation, subsurface data can be collected through, for example, an LWD survey.

At block 510 information from the subsurface data (such as, for example, a real time resistivity log) can be compared with corresponding synthetic data from the initial 3D Model Rₒ. At block 512, if the subsurface data and synthetic data have a matching resolution (i.e. are within predetermined measurement errors), then method 500 can return to block 508. Otherwise, if the subsurface data and synthetic data do not have a matching resolution, method 500 can continue to block 514.

At block 514, in one possible implementation, a quality of the subsurface data, including that collected via an LWD survey, can be examined using any method known in the art. In one possible embodiment, the subsurface data can include, for example, logs of resistivity, etc.

If the quality of any portion of the subsurface data is found to be unacceptable at block 514, or if any questions exist regarding the quality of any portion of the subsurface data, method 500 can continue to block 516, where problems in the subsurface data can be sought and corrected before returning to block 514 for renewed quality testing of the corrected subsurface data.

Alternately, if at block 514, the quality of the subsurface data is found to be acceptable, then method 500 can continue to block 518.

At block 518, the subsurface data can be used to constrain and/or refine the initial 3D Model Rₒ to create a revised 3D model Rₘ (such as, for example, revised 3D model 400).

At block 520, information from revised 3D model Rₘ can be used to create a revised trajectory (such as, for example, revised trajectory 406) and a revised synthetic resistivity log along the revised trajectory.

In one possible implementation, drilling of the well can be guided along the revised trajectory, and various blocks of method 500 (such as one or more blocks within border 522) can be repeated. For instance, subsurface data can be collected as drilling proceeds along the revised trajectory (i.e. repeat block 508). Then method 500 can proceed as described above. Repetition like this can happen as many times as desired, resulting in successive refinements of the 3D models and proposed drilling trajectories. In one possible implementation, method 500 can terminate once the well being drilled reaches and penetrates a desired sweet spot (such as sweet spot 308).

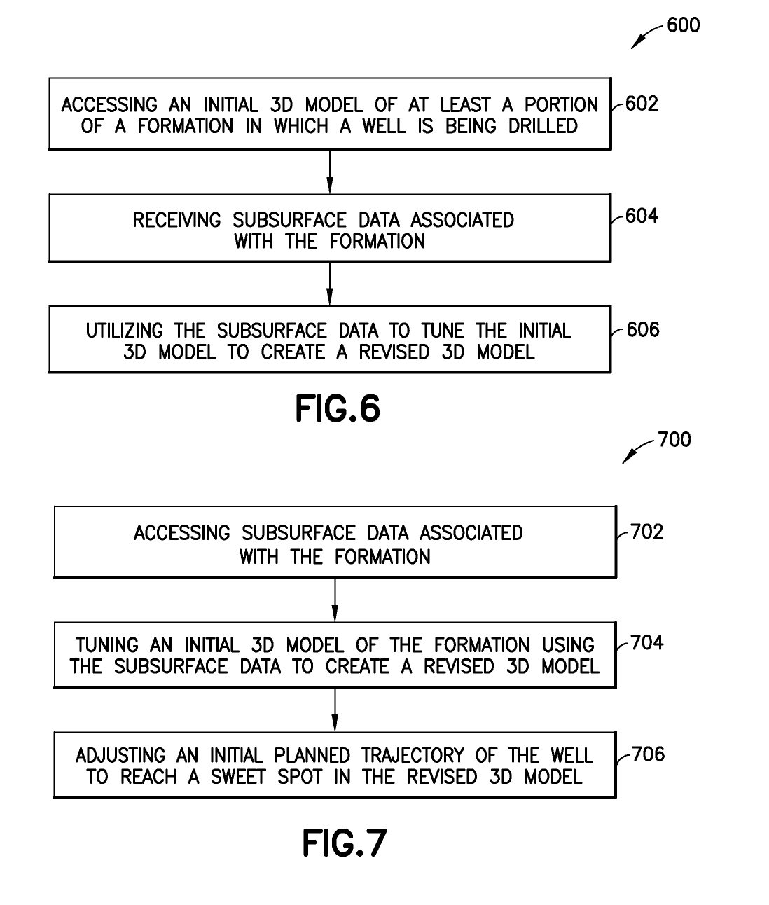

FIG. 6 illustrates another example method 600 associated with embodiments of well trajectory adjustment. At block 602, an initial 3D model (such as initial 3D model 300) of at least a portion of a formation (such as formation 142) in which a well (such as, for example, well 310) is being drilled is accessed. In one possible embodiment, this includes accessing a premade initial 3D model. In another possible implementation, this includes creating an initial 3D model using various information associated with the formation.

Initial 3D model 300 can include any 3D model known in the art, including, for example, 3D resistivity models, 3D gravity models, etc., and can be created using any technologies known in the art, including, for example electromagnetic (EM) surveying technologies.

At block 604 subsurface data associated with the formation is received. The surface data can be associated with various aspects of the formation and/or equipment being used to drill the well. For example, subsurface data can include data collected using one or more downhole instruments (such as, for example, equipment 130 and/or sensors 140, etc.) as well as data associated with one or more formation materials such as advance fluids, cuttings, etc., received from the drilling of the well. Subsurface data can also include electromagnetic (EM) measurements of formation (including, for example, real time deep, directional EM measurements), and logs of resistivity, pressure and/or temperature based on logging-while-drilling (LWD) data associated with the well being drilled.

In one possible implementation, subsurface data can be acquired through various resistivity logging services. Such services, including those performed at LWD module 132 can, for example, reveal subsurface-bedding and fluid-contact details in proximity to a borehole being drilled.

At block 606 the subsurface data can be used to tune the initial 3D model to create a revised 3D model (such as, for example, revised 3D model 400). For instance, in one possible implementation, the initial 3D model can be constrained and/or refined using some or all of the subsurface data to create the revised 3D model. In one possible embodiment, some or all of the subsurface data can be used to reprocess the initial 3D model, leading to improved definition (as drilling of the well progresses) of, for example, bed geometries, lateral changes in the resistivity volume, etc.

In one possible aspect, the revised 3D model may be similar to the initial 3D model, though the spatial distribution of various features, including resistivity features, can be changed. For example, in one possible embodiment, the location, orientation, size, etc., of a sweet spot (such as sweet spot 308) in the revised 3D model may be different than that found in initial 3D model 300.

In one possible implementation, an initial planned trajectory of a well being drilled can be adjusted to create a revised trajectory of the well based at least in part on the revised 3D model.

FIG. 7 illustrates another example method 700 associated with embodiments of well trajectory adjustment. At block 702, subsurface data associated with a formation (such as formation 142) is accessed. The surface data can be associated with various aspects of the formation and/or equipment being used to drill a well in the formation. For example, subsurface data can include data collected using one or more downhole instruments (such as, for example, equipment 130, sensors 140, etc.) as well as data associated with one or more formation materials such as advance fluids, cuttings, etc., received from the drilling of the well. Subsurface data can also include electromagnetic (EM) measurements of formation (including, for example, real time deep, directional EM measurements), and logs of resistivity, pressure and/or temperature based on logging-while-drilling (LWD) data associated with the well being drilled.

In one possible implementation, subsurface data can be acquired through various resistivity logging services. Such services, including those performed at LWD module 132 can, for example, reveal subsurface-bedding and fluid-contact details in proximity to a borehole being drilled.

At block 704 an initial 3D model of the formation can be tuned using the subsurface data to create a revised 3D model. The initial 3D model (such as initial 3D model 300) can include any 3D model known in the art, including, for example, 3D resistivity models, 3D gravity models, etc., and can be created using any technologies known in the art, including, for example electromagnetic (EM) surveying technologies. In one possible implementation, the subsurface data can be used to tune the initial 3D model to create the revised 3D model (such as, for example, revised 3D model 400) by constraining and/or refining the initial 3D model based on some or all of the subsurface data. For example, in one possible embodiment, some or all of the subsurface data can be used to reprocess the initial 3D model, leading to improved definition as drilling of a well in the formation, such as well 310, progresses.

In one possible aspect, the revised 3D model may be similar to the initial 3D model, though the spatial distribution of various features, including resistivity features, can be changed.

At block 706 an initial planned trajectory (such as initial planned trajectory 312) of the well can be adjusted to reach a sweet spot in the revised 3D model. For example, in one possible embodiment, the location, size, orientation, etc., of a sweet spot (such as sweet spot 308) in the revised 3D model may be different than that found in initial 3D model 300.

Thus the initial planned trajectory of a well being drilled can be adjusted based on the revised 3D model to create a revised trajectory of the well (such as revised trajectory 406) to more efficiently reach the sweet spot.

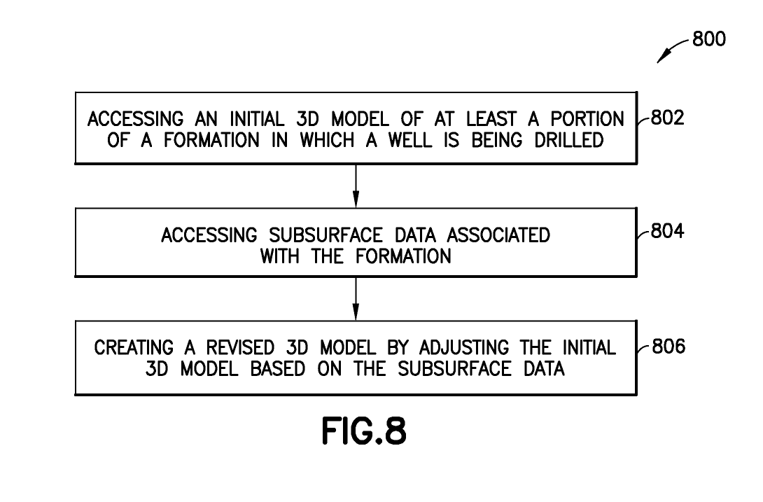

FIG. 8 illustrates yet another example method 800 associated with embodiments of well trajectory adjustment. At block 802, an initial 3D model (such as initial 3D model 300) of at least a portion of a formation (such as formation 142) in which a well (such as, for example, well 310) is being drilled is accessed. In one possible embodiment, this includes accessing a premade initial 3D model. In another possible implementation, this includes creating an initial 3D model using various information associated with the formation.

Initial 3D model 300 can include any 3D model known in the art, including, for example, 3D resistivity models, 3D gravity models, etc., and can be created using any technologies known in the art, including, for example electromagnetic (EM) surveying technologies.

At block 804 subsurface data associated with the formation is accessed. The surface data can be associated with various aspects of the formation and/or equipment being used to drill the well. For example, subsurface data can include data collected using one or more downhole instruments (such as, for example LWD module 132, MWD module 134, and/or sensors 140, etc.). Subsurface data can also include data associated with one or more formation materials such as advance fluids, cuttings, etc., received from the drilling of the well. Subsurface data can also include electromagnetic (EM) measurements of formation (including, for example, real time deep, directional EM measurements), and logs of resistivity, pressure and/or temperature based on logging-while-drilling (LWD) data associated with the well being drilled.

In one possible implementation, subsurface data can be accessed from various resistivity logging services. Such services, including those performed at LWD module 132 can, for example, reveal subsurface-bedding and fluid-contact details in proximity to the well being drilled in the formation.

At block 806, a revised 3D model (such as revised 3D model 400) can be created by adjusting the initial 3D model based on the subsurface data. For instance, in one possible implementation, initial 3D model can be constrained and/or refined using some or all of the subsurface date to create the revised 3D model. In one possible embodiment, some or all of the subsurface data can be used to reprocess the initial 3D model, leading to improved definition (as drilling of well 310 progresses) of, for example, bed geometries, lateral changes in the resistivity volume, etc. of elements in the initial 3D model.

In one possible aspect, the revised 3D model may be similar to the initial 3D model, though the spatial distribution of various features, including resistivity features, can be changed and/or improved. For example, in one possible embodiment, the location, size, orientation, etc., of a sweet spot (such as sweet spot 308) in the revised 3D model may be different than that found in initial 3D model 300.

Although only a few example embodiments have been described in detail above, those skilled in the art will readily appreciate that many modifications are possible in the example embodiments without materially departing from this disclosure. Accordingly, such modifications are intended to be included within the scope of this disclosure as defined in the following claims. Moreover, embodiments may be performed in the absence of any component not explicitly described herein.

In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. A method of well trajectory adjustment comprising:
accessing an initial 3D model of at least a portion of a formation in which a well is being drilled;
receiving subsurface data associated with the formation; and
utilizing the subsurface data to tune the initial 3D model to create a revised 3D model.

2. The method of claim 1, wherein accessing an initial 3D model includes accessing a 3D gravity model of a least a portion of the formation.

3. The method of claim 1, wherein accessing an initial 3D model includes accessing an anisotropic 3D resistivity model of a least a portion of the formation.

4. The method of claim 1, receiving subsurface data includes one or more of:
receiving logging while drilling data associated with the well; and
receiving data associated with one or more formation materials collected from the well.

5. The method of claim 1, wherein utilizing the subsurface data to tune the initial 3D model to create a revised 3D model includes more accurately locating a hydrocarbon sweet spot in the revised 3D model.

6. The method of claim 1, further comprising:
adjusting an initial planned trajectory of the well based on the revised 3D model to create a revised trajectory of the well.

7. The method of claim 6, further comprising:
directing a steerable drill bit to pursue the revised trajectory of the well.

8. The method of claim 1, further comprising:
utilizing the revised 3D model to construct a fluid saturation cube associated with at least a portion of the formation.

9. A method of tuning a trajectory of a well being drilled in a formation comprising:
accessing subsurface data associated with the formation;
tuning an initial 3D model of the formation using the subsurface data to create a revised 3D model; and
adjusting an initial planned trajectory of the well to reach a sweet spot in the revised 3D model.

10. The method of claim 9, wherein accessing an initial 3D model includes one or more of:
accessing a 3D gravity model of the formation; and
accessing an anisotropic 3D resistivity model of the formation.

11. The method of claim 9, wherein tuning an initial 3D model of the formation includes one or more of:
receiving logging while drilling data associated with the well; and
receiving data associated with one or more formation materials collected from the well.

12. The method of claim 9, wherein tuning an initial 3D model of the formation includes updating at least some information associated with the sweet spot in the formation.

13. The method of claim 9, wherein tuning an initial 3D model of the formation includes improving an accuracy of the initial 3D model of the formation using one or more portions of the subsurface data.

14. The method of claim 9, further comprising:
directing a steerable drill bit towards the sweet spot in the revised 3D model.

15. The method of claim 9, further comprising:
combining the revised 3D model with a 3D density model of the formation to generate a 3D pressure volume model associated with the formation; and
generating from the 3D pressure volume model a 3D window of mud weight within the well at one or more depths in the well.

16. A computer-readable tangible medium with instructions stored thereon that, when executed, direct a processor to perform acts comprising:
accessing an initial 3D model of at least a portion of a formation in which a well is being drilled;
accessing subsurface data associated with the formation; and
creating a revised 3D model by adjusting the initial 3D model based on the subsurface data.

17. The computer-readable medium of claim 16, further including instructions to direct a processor to perform acts comprising:
utilizing the revised 3D model to generate volumes of one or more fluid types in the at least a portion of the formation; and
deriving a 3D bulk matrix associated with the at least a portion of the formation by subtracting the generated volumes from the revised 3D model.

18. The computer-readable medium of claim 16, further including instructions to direct a processor to perform acts comprising:
formulating an initial planned trajectory of the well based on the initial 3D model.

19. The computer-readable medium of claim 18, further including instructions to direct a processor to perform acts comprising:
adjusting the initial planned trajectory of the well based on the revised 3D model to create a revised trajectory of the well:

20. The computer-readable medium of claim 16, further including instructions to direct a processor to perform acts comprising:
issuing instructions to direct a steerable drill bit toward a hydrocarbon sweet spot in the revised 3D model.
